(19) United States
(12) Patent Application Publication
(10) Pub. No.: US 2012/0230907 A1
(43) Pub. Date: Sep. 13, 2012

(54) PROCESS FOR PRODUCING CARBON MATERIAL

(75) Inventors: Kosuke Kurakane, Ibaraki-shi (JP); Taketoshi Kikuchi, Ibaraki-shi (JP); Toyomochi Tamato, Nishinomiya-shi (JP)

(73) Assignee: Sumitomo Chemical Company Limited, Tokyo (JP)

(21) Appl. No.: 12/808,602

(22) PCT Filed: Dec. 8, 2008
(86) PCT No.: PCT/JP2008/072721

§ 371 Date: Sep. 3, 2010

(30) Foreign Application Priority Data
Dec. 19, 2007 (JP) 2007 326961

(51) Int. Cl. C01B 31/02

(52) U.S. Cl. 423/445 R

(57) ABSTRACT

A process for producing a carbon material comprising heating a compound represented by the formula (1): wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonyl group, a nitro group, a C1-C6 thioalkyl group, a cyano group, a carboxyl group, an amino group, a C2-C20 acylamino group and a halogen atom, R′ represents a hydrogen atom or a methyl group, and n represents an integer of 3 to 7, at 800 to 3,000° C. under an inert gas atmosphere.

### FIELD OF THE INVENTION

The present invention relates to a process for producing a carbon material.

### BACKGROUND OF THE INVENTION

Carbon materials are used as materials for electrodes in electric double-layer capacitors, lithium ion capacitors, lithium ion secondary cells, sodium ion secondary cells and the like.

JP 2007-8790 A discloses that carbon materials having a lot of meso pores of which pore diameter is 2 to 50 nm are useful for electrode materials in electric double-layer capacitors. JP 2007-8790 A also discloses a process for producing a carbon material comprising carbonizing a resin composite obtained by modifying a thermosetting resin with a silicon compound and removing silica derived from the silicon compound.

### DISCLOSURE OF THE INVENTION

The present invention provides the followings:
[1] A process for producing a carbon material comprising heating a compound represented by the formula (1):

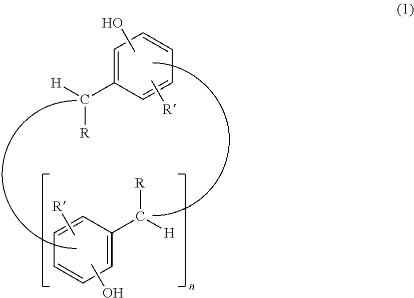

wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 alkylthio group, a cyano group, a carboxyl group, an amino group, a C2-C20 acylamino group, a carbamoyl group and a halogen atom, R′ represents a hydrogen atom or a methyl group, and n represents an integer of 3 to 7, at 800 to 3,000° C. under an inert gas atmosphere;
[2] A process for producing a carbon material comprising heating a compound represented by the formula (1):

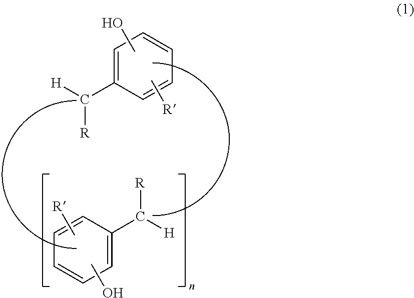

wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 alkylthio group, a cyano group, a carboxyl group, an amino group, a C2-C20 acylamino group, a carbamoyl group and a halogen atom, R′ represents a hydrogen atom or a methyl group, and n represents an integer of 3 to 7, at 200 to 400° C. under an oxidizing gas atmosphere to obtain a calcined product, and heating the calcined product at 800 to 3,000° C. under an inert gas atmosphere;
[3] The process according to [1] or [2], wherein R′ represents a hydrogen atom;
[4] The process according to [1], [2] or [3], wherein R represents a hydrogen atom;
[5] The process according to any one of [1] to [4], wherein n represents 3 or 7;
[6] The process according to any one of [1] to [4], wherein n represents 7;
[7] A process for producing fine particles of a carbon material comprising heating a compound represented by the formula (1):

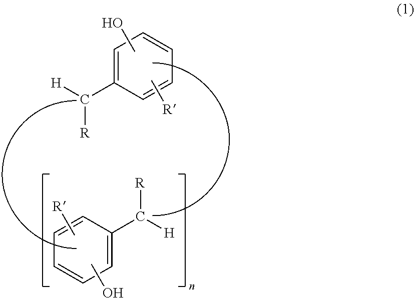

wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 alkylthio group, a cyano group, a carboxyl group, an amino group, a C2-C20 acylamino group, a carbamoyl group and a halogen atom, R′ represents a hydrogen atom or a methyl group, and n represents an integer of 3 to 7, at 800 to 3,000° C. under an inert gas atmosphere to obtain a carbon material, and grinding the carbon material obtained;
[8] A process for producing fine particles of a carbon material comprising heating a compound represented by the formula (1):

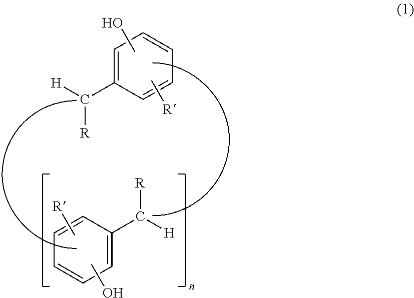

wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 alkylthio group, a cyano group, a carboxyl group, an amino group, a C2-C20 acylamino group, a carbamoyl group and a halogen atom, R′ represents a hydrogen atom or a methyl group, and n represents an integer of 3 to 7, at 200 to 400° C. under an oxidizing gas atmosphere to obtain a calcined product, heating the calcined product at 800 to 3,000° C. under an inert gas atmosphere to obtain a carbon material, and grinding the carbon material obtained;
[9] The process according to [7] or [8], wherein R′ represents a hydrogen atom;
[10] The process according to [7], [8] or [9], wherein R represents a hydrogen atom;
[11] The process according to any one of [7] to [10], wherein n represents 3 or 7; and
[12] The process according to any one of [7] to [10], wherein n represents 7.

### MODES FOR CARRYING OUT THE INVENTION

In the formula (1), R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom.

Examples of the C1-C12 hydrocarbon group include a C1-C6 linear or branched chain alkyl group such as a methyl group, an ethyl group, a propyl group, an isopropyl group, a butyl group, an isobutyl group, a tert-butyl group, a pentyl group and a hexyl group; a C3-C6 cycloalkyl group such as a cyclopentyl group and a cyclohexyl group; a C6-C20 aromatic hydrocarbon group such as a phenyl group, a 2-methylphenyl group, a 3-methylphenyl group, a 4-methylphenyl group and a naphthyl group; and a C7-C20 aralkyl group such as a benzyl group and a 2-phenylethyl group. The C6-C20 aromatic hydrocarbon group is preferable.

Examples of the C1-C6 alkoxy group include a methoxy group, an ethoxy group, a propoxy group, an isopropoxy group, a butoxy group, an isobutoxy group, a tent-butoxy group, a pentyloxy group and a hexyloxy group.

Examples of the C6-C20 aryloxy group include a phenoxy group, a 2-methylphenoxy group, a 3-methylphenoxy group, a 4-methylphenoxy group and a naphthoxy group.

Examples of the C1-C6 alkylthio group include a methylthio group, an ethylthio group, a propylthio group, an isopropylthio group, a butylthio group, an isobutylthio group, a tert-butylthio group, a pentylthio group and a hexylthio group.

Examples of the C2-C20 acylamino group include an acetylamino group, a propionylamino group and a benzoylamino group.

Examples of the halogen atom include a fluorine atom, a chlorine atom, a bromine atom and an iodine atom.

Examples of the C1-C12 hydrocarbon group substituted with at least one selected from the group consisting of a hydroxyl group, a C1-C6 alkoxy group, a C6-C20 aryloxy group, a sulfonic acid group (—SO₃H), a nitro group, a C1-C6 thioalkyl group, a cyano group, a carboxyl group, an amino group, a C2-C20 acylamino group, a carbamoyl group and a halogen atom include a 2-hydroxyphenyl group, a 3-hydroxyphenyl group, a 4-hydroxyphenyl group, a 2-methoxyphenyl group, a 3-methoxyphenyl group, a 4-methoxyphenyl group, a 2-chlorophenyl group, a 3-chlorophenyl group, a 4-chlorophenyl group, a 2-bromophenyl group, a 3-bromphenyl group, a 4-bromophenyl group, a 2-fluorophenyl group, a 3-fluorophenyl group, a 4-fluorophenyl group, a 2-methylthiophenyl group, a 3-methylthiophenyl group, a 4-methylthlophenyl group, a 2-carboxyphenyl group, a 3-carboxyphenyl group, a 4-carboxyphenyl group, a 3-nitrophenyl group, a 4-aminophenyl group, a 4-cyanophenyl group, a 4-acetylaminophenyl group. a 2-hydroxybenzyl group, a 3-hydroxybenzyl group and a 4-hydroxybenzyl group.

R is preferably a hydrogen atom or the C6-C20 aromatic hydrocarbon group which may be substituted with at least one group described above, and R is more preferably a hydrogen atom or the C6-C20 aromatic hydrocarbon group which may be substituted with a hydroxyl group, and R is especially preferably a hydrogen atom.

R′ represents a hydrogen atom or a methyl group, and preferably represents a hydrogen atom.

The hydroxyl group bonding to a benzene ring of the formula (1) is usually bonded at ortho-position of —CH(R)— group.

In the formula (1), n represents an integer of 3 to 7, preferably 3 or 7, and more preferably 7.

The compound represented by the formula (1) (hereinafter, simply referred to as the compound (1)) has stereoisomers, and any one of stereoisomers may be used and a mixture of stereoisomers may be used.

When n represents 3, the compound (1) is a compound represented by the formula (I):

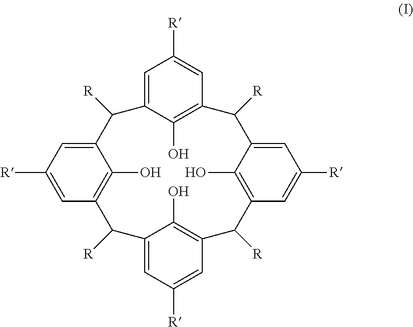

wherein R and R′ represent the same meanings as described above.

Examples of the compound represented by the formula (I) include

the compound represented by the formula (I) wherein R and R′ are hydrogen atoms,

the compound represented by the formula (I) wherein R is a hydrogen atom and R′ is a methyl group,

the compound represented by the formula (I) wherein R is a methyl group and R′ is a hydrogen atom,

the compound represented by the formula (I) wherein R and R′ are methyl groups,

the compound represented by the formula (I) wherein R is a phenyl group and R′ is a hydrogen atom, and

the compound represented by the formula (I) wherein R is a phenyl group and R′ is a methyl group.

The compound (1) wherein n represents 5 is a compound represented by the following formula (II):

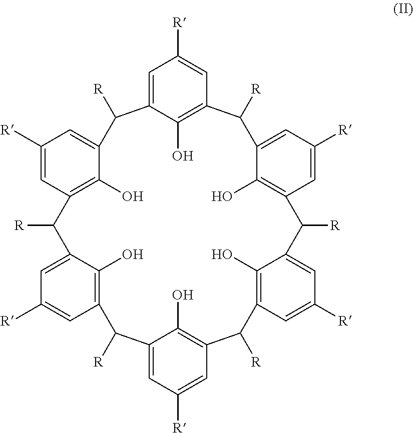

wherein R and R′ represent the same meanings as described above.

Examples of the compound represented by the formula (II) include

the compound represented by the formula (II) wherein R and R′ are hydrogen atoms,

the compound represented by the formula (II) wherein R is a hydrogen atom and R′ is a methyl group,

the compound represented by the formula (II) wherein R is a methyl group and R′ is a hydrogen atom,

the compound represented by the formula (II) wherein R and R′ are methyl groups,

the compound represented by the formula (II) wherein R is a phenyl group and R′ is a hydrogen atom, and

the compound represented by the formula (II) wherein R is a phenyl group and R′ is a methyl group.

The compound (1) wherein n represents 7 is a compound represented by the following formula (III):

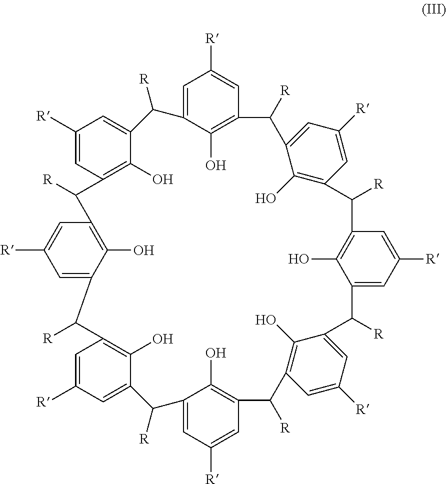

wherein R and R′ represent the same meanings as described above.

Examples of the compound represented by the formula (III) include

the compound represented by the formula (III) wherein R and R′ are hydrogen atoms,

the compound represented by the formula (III) wherein R is a hydrogen atom and R′ is a methyl group,

the compound represented by the formula (III) wherein R is a methyl group and R′ is a hydrogen atom,

the compound represented by the formula (III) wherein R and R′ are methyl groups,

the compound represented by the formula (III) wherein R is a phenyl group and R′ is a hydrogen atom, and

the compound represented by the formula (III) wherein R is a phenyl group and R′ is a methyl group.

The compound (1) can be produced by reacting a phenol compound represented by the formula (2):

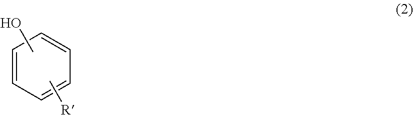

wherein R′ represents the same meaning as defined above (hereinafter, simply referred to as the phenol compound (2)), with an aldehyde compound represented by the formula (3):

R—CHO (3)

wherein R represents the same meaning as defined above (hereinafter, simply referred to as the aldehyde compound (3)) in the presence of a base catalyst to obtain the crude compound (1) followed by a purification of the crude compound (1) (e.g. J. Am. Chem. Soc., 103, 3782-3792 (1981) and Org. Synth., 68, 234-237 (1990)).

Examples of the phenol compound (2) include phenol, o-cresol, m-cresol and p-cresol, and phenol and p-cresol are preferable. A commercially available phenol compound (2) is usually used.

Examples of the aldehyde compound (3) include an aliphatic aldehyde compound such as formaldehyde, acetaldehyde, n-butylaldehyde, and an aromatic aldehyde compound such as benzaldehyde, 1-naphthaldehyde, p-methylbenzaldehyde, m-methylbenzaldehyde, p-methylbenzaldehyde, o-hydroxybenzaldehyde, m-hydroxybenzaldehyde, p-hydroxybenzaldehyde, p-tert-butylbenzaldehyde, p-phenylbenzaldehyde, o-methoxybenzaldehyde, m-methoxybenzaldehyde, p-methoxybenzaldehyde, o-chlorobenzaldehyde, m-chlorobenzaldehyde, p-chlorobenzaldehyde, o-bromobenzaldehyde, m-bromobenzaldehyde, p-bromobenzaldehyde, o-fluorobenzaldehyde, m-fluorobenzaldehyde, p-fluorobenzaldehyde, o-methylthiobenzaldehyde, m-methylthiobenzaldehyde, p-methylthiobenzaldehyde, o-carboxybenzaldehyde, m-carboxybenzaldehyde, p-carboxybenzaldehyde, m-nitrobenzaldehyde, p-aminobenzaldehyde and p-acetylaminobenzaldehyde. The aliphatic aldehyde compound is preferable and formaldehyde is more preferable. A commercially available aldehyde compound (3) is usually used.

The amount of the aldehyde compound (3) is usually 1 to 3 moles and preferably 1.2 to 2.5 moles per 1 mole of the phenol compound.

Examples of the base catalyst include an alkali metal hydroxide such as sodium hydroxide and potassium hydroxide, and an alkali metal alkoxide such as potassium tert-butoxide.

The compound (1) can also be produced according to the method described in JP 59-104333 A, JP 2000-16955 A, JP 2000-191574 A, Makromol. Chem., Rapid Commun., 3, 705-707 (1982), Makromol. Chem., Rapid Commun., 3, 65-67 (1982) or the like.

A commercially available compound (1) may be used.

The process for producing a carbon material of the present invention comprises heating the compound (1) under an inert gas atmosphere at 800 to 3,000° C., preferably at 2,500 to 3,000° C. and more preferably at 2,800 to 3,000° C.

In this specification, “an inert gas” means a gas not reacting with an organic compound.

Examples of the inert gas include nitrogen and a rare gas such as helium, neon, argon, krypton and xenon.

The heating time is usually 1 minute to 24 hours.

The bulk density of the obtained carbon material tends to improve by heating at 800° C. or more. The heating at 3000° C. or less tends to inhibit graphitization of the carbon material.

The heating is preferably conducted in a calcining furnace such as a rotary kiln, a roller hearth kiln, a pusher kiln, a multiple-hearth furnace, a fluidized bed furnace, a high-temperature calcining furnace. The rotary kiln is more preferably used in viewpoint that much amount of the compound (1) can easily be heated.

The heating is usually conducted by placing the compound (1) in a calcining furnace, putting an inert gas into the calcining furnace, and heating at 800 to 3,000° C. for a given time.

The carbon material is also produced by heating the compound (1) at 200 to 400° C. under an oxidizing gas atmosphere to obtain a calcined product, and heating the calcined product at 800 to 3,000° C. under an inert gas atmosphere.

The heating time at 200 to 400° C. under an oxidizing gas atmosphere is usually 1 minute to 24 hours.

In this specification, “an oxidizing gas” means a gas being capable of reacting with an organic compound to oxidize the organic compound.

Examples of the oxidizing gas include H₂O, CO₂, O₂, and air, and O₂ and air are preferable.

The heating under an inert gas atmosphere after heating at 200 to 400° C. under an oxidizing gas atmosphere is conducted at 800 to 3,000° C., preferably at 2,500 to 3,000° C. and more preferably at 2,800 to 3,000° C.

The heating time at 800 to 3,000° C. after heating at 200 to 400° C. under an oxidizing gas atmosphere is usually 1 minute to 24 hours.

The heating is preferably conducted in a calcining furnace and examples of the calcining furnace include the same as described above. The rotary kiln is more preferably used in viewpoint that much amount of the compound (1) can easily be heated.

The heating is usually conducted by placing the compound (1) in a calcining furnace, putting an oxidizing gas into the calcining furnace, heating at 200 to 400° C. for a given time, putting an inert gas into the calcining furnace, and then heating at 800 to 3,000° C. for a given time.

The carbon material thus obtained can be used for materials for electrodes in dry batteries, sensor for a piezoelectric devices, electric double-layer capacitors, lithium ion capacitors, lithium ion secondary cells, sodium ion secondary cells, carriers for supporting catalysts, carriers for chromatography, adsorbents and the like.

The carbon material thus obtained is usually ground to carbon fine particles having an average particle size of 50 μm or less, preferably 30 μm or less, and more preferably 10 μm or less to used for electrodes.

Examples of the suitable grinding methods include methods of grinding using a grinding machine for fine grinding such as an impact wear grinder, a centrifugal grinder, a ball mill (e.g. a tube mill, a compound mill, a conical ball mill, a rod mill and a planetary ball mill), a vibration mill, a colloid mill, a friction disk mill and a jet mill, and the ball mill is usually used as the grinding machine. When the ball mill is used, balls and grinding vessels made of non-metals such as alumina and agate is preferable in viewpoint of avoiding incorporation of metal powders in the carbon fine particles obtained.

### EXAMPLES

The present invention will be illustrated in more detail based on Examples bellow, but the present invention is not limited to these Examples.

The total pore volume of the carbon materials obtained was calculated from nitrogen adsorption amount around a relative pressure of 0.95 in a nitrogen adsorption isothermal curve at liquid nitrogen temperature using AUTOSORB manufactured by YUASA IONICS. The meso pore volume of the carbon materials obtained was calculated from a nitrogen adsorption isothermal curve using BHJ method. The meso pore ratio was calculated by dividing the meso pore volume of the carbon materials obtained by the total pore volume of the carbon materials obtained and was expressed in percentage.

### Example 1

The compound represented by the formula (a):

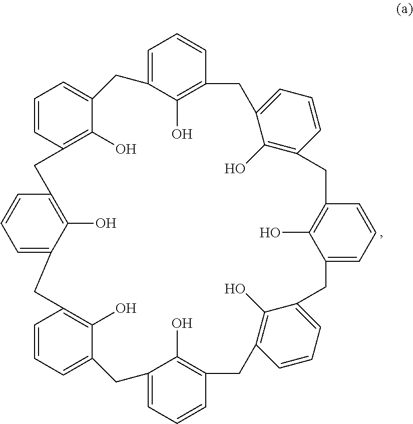

which was manufactured by Wako Pure Chemical Industries, Ltd., was heated at 1,000° C. for 4 hours in the rotary kiln under an argon atmosphere to obtain carbon materials. The obtained carbon materials were ground using a ball mill having a ball made of agate at 28 rpm for 5 minutes to obtain fine particles of carbon materials.

The result is shown in Table 1.

### Example 2

The compound represented by the above-mentioned formula (a), which was the same as used in Example 1, was heated at 1,300° C. for 4 hours in the rotary kiln under an argon atmosphere to obtain carbon materials. The obtained carbon materials were ground using a ball mill having a ball made of agate at 28 rpm for 5 minutes to obtain fine particles of carbon materials.

The result is shown in Table 1.

### Example 3

The compound represented by the above-mentioned formula (a), which was the same as used in Example 1, was heated at 1,500° C. for 4 hours in the rotary kiln under an argon atmosphere to obtain carbon materials. The obtained carbon materials were ground using a ball mill having a ball made of agate at 28 rpm for 5 minutes to obtain fine particles of carbon materials.

The result is shown in Table 1.

### Example 4

The compound represented by the above-mentioned formula (a), which was the same as used in Example 1, was heated at 1,800° C. for 4 hours in the rotary kiln under an argon atmosphere to obtain carbon materials. The obtained carbon materials were ground using a ball mill having a ball made of agate at 28 rpm for 5 minutes to obtain fine particles of carbon materials.

The result is shown in Table 1.

### Example 5

The compound represented by the above-mentioned formula (a), which was the same as used in Example 1, was heated at 2,000° C. for 4 hours in the rotary kiln under an argon atmosphere to obtain carbon materials. The obtained carbon materials were ground using a ball mill having a ball made of agate at 28 rpm for 5 minutes to obtain fine particles of carbon materials.

The result is shown in Table 1.

### Example 6

The compound represented by the above-mentioned formula (a), which was the same as used in Example 1, was heated at 2,800° C. for 4 hours in the rotary kiln under an argon atmosphere to obtain carbon materials. The obtained carbon materials were ground using a ball mill having a ball made of agate at. 28 rpm for 5 minutes to obtain fine particles of carbon materials.

The result is shown in Table 1.

### Example 7

The compound represented by the formula (b):

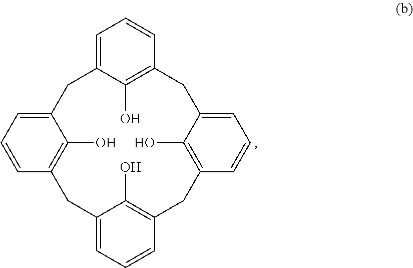

which was manufactured by Wako Pure Chemical Industries, Ltd., was heated at 1,000° C. for 4 hours in the rotary kiln under an argon atmosphere to obtain carbon materials. The obtained carbon materials were ground using a ball mill having a ball made of agate at 28 rpm for 5 minutes to obtain fine particles of carbon materials.

The result is shown in Table 1.

TABLE 1

| | Total pore | Meso pore | Meso pore |
|---|---|---|---|
| Example | volume (ml/g) | volume (ml/g) | ratio (%) |
| 1 | 0.13 | 0.12 | 92 |
| 2 | 0.26 | 0.13 | 50 |
| 3 | 0.07 | 0.06 | 86 |
| 4 | 0.22 | 0.15 | 68 |
| 5 | 0.11 | 0.10 | 91 |
| 6 | 0.13 | 0.12 | 92 |
| 7 | 0.03 | 0.03 | 100 |

### Example 8

The compound represented by the above-mentioned formula (a), which was the same as used in Example 1, was heated at 300° C. for 1 hour in the rotary kiln under an air atmosphere to obtain a calcined product. The calcined product was heated at 1,000° C. for 4 hours under an argon atmosphere to obtain carbon materials. The obtained carbon materials were ground using a ball mill having a ball made of agate at 28 rpm for 5 minutes to obtain fine particles of carbon materials.

The result is shown in Table 2.

### Example 9

The compound represented by the above-mentioned formula (b), which was the same as used in Example 7, was heated at 300° C. for 1 hour in the rotary kiln under an air atmosphere to obtain a calcined product. The calcined product was heated at 1,000° C. for 4 hours under an argon atmosphere to obtain carbon materials. The obtained carbon materials were ground using a ball mill having a ball made of agate at 28 rpm for 5 minutes to obtain fine particles of carbon materials.

The result is shown in Table 2.

TABLE 2

| | Total pore | Meso pore | Meso pore |
|---|---|---|---|
| Example | volume (ml/g) | volume (ml/g) | ratio (%) |
| 8 | 0.35 | 0.13 | 37 |
| 9 | 0.04 | 0.03 | 75 |

### INDUSTRIAL APPLICABILITY

According to the present invention, a carbon material having a high meso pore ratio can be produced.

1. A process for producing a carbon material comprising heating a compound represented by the formula (1): 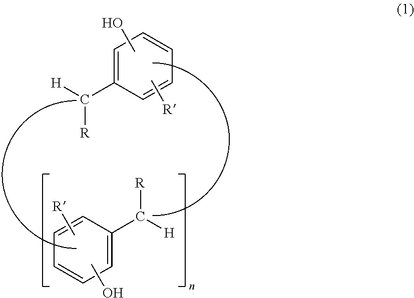
wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 alkylthio group, a cyano group, a carboxyl group, an amino group, a C2-C20 acylamino group, a carbamoyl group and a halogen atom, R′ represents a hydrogen atom or a methyl group, and n represents an integer of 3 to 7, at 800 to 3,000° C. under an inert gas atmosphere.

2. A process for producing a carbon material comprising heating a compound represented by the formula (1): 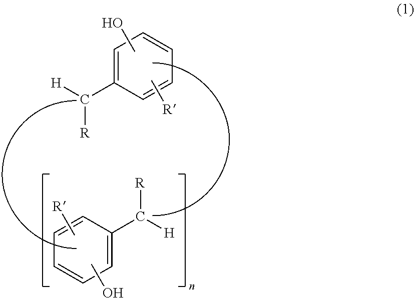
wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 alkylthio group, a cyano group, a carboxyl group, an amino group, a C2-C20 acylamino group, a carbamoyl group and a halogen atom, R′ represents a hydrogen atom or a methyl group, and n represents an integer of 3 to 7, at 200 to 400° C. under an oxidizing gas atmosphere to obtain a calcined product, and
heating the calcined product at 800 to 3,000° C. under an inert gas atmosphere.

3. The process according to claim 1 or 2, wherein R′ represents a hydrogen atom.

4. The process according to claim 1, wherein R represents a hydrogen atom.

5. The process according to claim 1, wherein n represents 3 or 7.

6. The process according to claim 1, wherein n represents 7.

7. A process for producing fine particles of a carbon material comprising heating a compound represented by the formula (1): 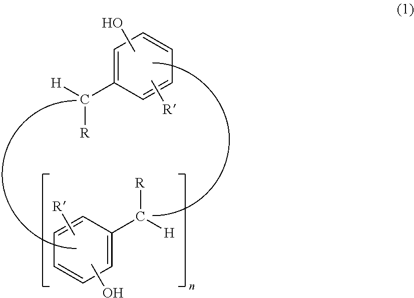
wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 alkylthio group, a cyano group, a carboxyl group, an amino group, a C2-C20 acylamino group, a carbamoyl group and a halogen atom, R′ represents a hydrogen atom or a methyl group, and n represents an integer of 3 to 7, at 800 to 3,000° C. under an inert gas atmosphere to obtain a carbon material, and
grinding the carbon material obtained.

8. A process for producing fine particles of a carbon material comprising heating a compound represented by the formula (1): 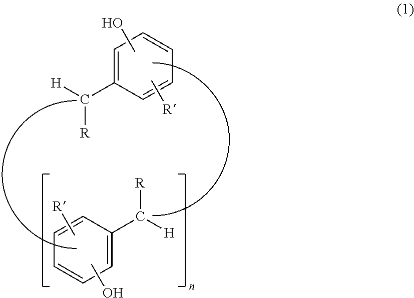
wherein R represents a hydrogen atom or a C1-C12 hydrocarbon group which may be substituted with at least one selected from the group consisting of a hydroxyl group, a C1-C6 alkoxy group, a C6-C20 aryloxy group, a sulfonic acid group (—SO₃H), a nitro group, a C1-C6 alkylthio group, a cyano group, a carboxyl group, an amino group, a C2-C20 acylamino group, a carbamoyl group and a halogen atom, R′ represents a hydrogen atom or a methyl group, and n represents an integer of 3 to 7, at 200 to 400° C. under an oxidizing gas atmosphere to obtain a calcined product, heating the calcined product at 800 to 3,000° C. under an inert gas atmosphere to obtain a carbon material, and
grinding the carbon material obtained.

9. The process according to claim 7 or 8, wherein R′ represents a hydrogen atom.

10. The process according to claim 7, wherein R represents a hydrogen atom.

11. The process according to claim 7, wherein n represents 3 or 7.

12. The process according to claim 7, wherein n represents 7.
